(19) United States
(12) Patent Application Publication
(10) Pub. No.: US 2017/0221351 A1
(43) Pub. Date: Aug. 3, 2017

(54) DEVICES AND METHODS FOR REMOTE CONTROL OF TARGET DEVICES

(71) Applicant: Lattice Semiconductor Corporation, Hillsboro, OR (US)

(72) Inventors: Thomas Watzka, Palo Alto, CA (US); Darin Billerbeck, Portland, OR (US)

(21) Appl. No.: 15/321,673

(22) PCT Filed: Jun. 26, 2015
(86) PCT No.: PCT/US15/38151

§ 371 Date: Dec. 22, 2016

Related U.S. Application Data
(60) Provisional application No. 62/019,675, filed on Jul. 1, 2014.

(51) Int. Cl. G08C 17/02

(52) U.S. Cl. CPC G08C 17/02; G08C 2201/93

(57) ABSTRACT

Various techniques are provided to program and operate a user device to remotely control target devices. In one example, a user may program a user device with a remote control device that includes physical controls. The user device may capture an image of the remote control device. The user device may determine a location on the image corresponding to a physical control. The user device may receive an infrared (IR) signal from the remote control device corresponding to an actuation of the physical control. The user device may associate the IR signal and the location. The user may operate the user device to control a target device. The user device may present the image to the user on a display. The user device may receive a user contact corresponding to a location on the image and transmit an IR signal associated with the location to operate the target device.

### CROSS-REFERENCE TO RELATED APPLICATIONS

This application is a National Stage of International Application No. PCT/US2015/038151 filed Jun. 26, 2015 and entitled “Devices and Methods for Remote Control of Target Devices”, which claims the benefit of U.S. Provisional Patent Application No. 62/019,675 filed Jul. 1, 2014 and entitled “Appliance Remote Control Method Using Smartphones”, all of which are hereby incorporated by reference in their entirety.

### TECHNICAL FIELD

The present disclosure relates generally to remote control and, more particularly, to programming and operating a user device to remotely control target devices.

### BACKGROUND

For decades, infrared (IR) remote controls have been used to control various target devices, such as audio/video equipment, consumer appliances, and other devices. Typically, each target device has its own dedicated remote control device which sends various IR signals to the target device in response to user actuation of buttons on the remote control device. For large systems with many target devices, the number of remote control devices become unwieldy and difficult to use.

Some conventional IR remote controls (e.g., referred to as “universal” remote controls) allow some programming of buttons to permit a single universal remote control to operate several target devices. Unfortunately, such universal remote controls typically use generic buttons or simple labels that bear little resemblance to the actual remote control devices that they are emulating. Some conventional mobile devices (e.g., smartphones) include IR transmitters which may be used to transmit IR signals for controlling target devices. However, similar to the above-mentioned universal remote controls, such mobile devices typically rely on applications with generic buttons or simple labels that differ from the actual remote control devices.

Moreover, such mobile device applications typically require a cloud-based database or locally stored database of hundreds or even thousands of possible target devices and their associated IR signal information. For cloud-based databases, significant licensing and/or access fees may be incurred. For local databases, a large amount of the mobile device's local memory may be used to store IR signal information for target devices that a user will never use, thereby wasting storage space on the local memory. Also, such mobile device applications often require more powerful system components, which in turn increase the cost of the mobile device.

In addition, all of the above-mentioned approaches require a substantial investment of time and effort to compile and update IR signal information for all known target devices. As such, the efficacy of such approaches depends on the database suppliers ability to maintain IR signal information for new and legacy target devices. Indeed, it is inevitable that IR signal information for some target devices will not be available in the databases.

### BRIEF DESCRIPTION OF THE DRAWINGS

FIG. 1 illustrates a block diagram of a system for programming and operating a user device to remotely control a target device in accordance with an embodiment of the disclosure.

FIG. 2 illustrates a block diagram of a user device in accordance with an embodiment of the disclosure.

FIG. 3 illustrates a block diagram of a programmable logic device (PLD) in accordance with an embodiment of the disclosure.

FIG. 4 illustrates a block diagram of a user device interacting with a remote control device in accordance with an embodiment of the disclosure.

FIG. 5 illustrates a block diagram of a user device interacting with a target device in accordance with an embodiment of the disclosure.

FIG. 6A illustrates a block diagram of a user device displaying an image of a remote control device in accordance with an embodiment of the disclosure.

FIG. 6B illustrates a block diagram of a user device placed within range of infrared signals of a remote control device in accordance with an embodiment of the disclosure.

FIG. 7 illustrates a flow diagram of programming a user device to remotely control a target device in accordance with an embodiment of the disclosure.

FIG. 8 illustrates a flow diagram of operating a user device to remotely control a target device in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with embodiments set forth herein, techniques are provided to program a user device with a remote control device and operate the user device to control a target device by using an image of the remote control device. As a result, the user may operate the target device in a manner that is natural and familiar to the user. For example, the user device may capture an image of a remote control device that includes at least one physical control (e.g., a button, a switch, a control stick, or other control). The user device may determine a location on the image corresponding to the physical control. For example, the user device may present the image to the user on a display, such as a touchscreen display, and the user may touch the image to designate the location. The user device may generate data identifying the location on the image based on the signal generated by the display in response to the user contact corresponding to the location. In another example, the user device may process the image to identify the physical control and select the physical control in the image to identify the location.

The user device may receive a wireless signal (e.g., an infrared (IR) signal, a radio frequency (RF) signal, a visible light signal, a Wi-Fi™ signal, a Bluetooth™ signal, or other wireless signal) from the remote control device corresponding to an actuation of the physical control. For example, the remote control device may transmit a wireless signal corresponding to an actuation of the physical control when the user actuates the physical control (e.g., press a button), and the user device may receive the wireless signal. The user device may determine the location before receiving the wireless signal. Alternatively, the user device may receive the wireless signal before determining the location.

The user device may then associate the wireless signal and the location on the image (e.g., an image location or data identifying the location), such as by storing a representation of the wireless signal and the location on the image. The user device may include a sensor processor (e.g., a programmable logic device (PLD) in some embodiments) that decodes the wireless signal to provide command code data, which may be stored as the representation of the wireless signal. In an example, the user device may associate the wireless signal and the location by a main processor of the user device storing an association between the command code and the location in a memory of the user device. In another example, the sensor processor may associate the wireless signal and the location by the sensor processor storing the command code data at one or more memory location, and a main processor of the user device storing an association between a memory address associated with the one or more memory locations and the location on the image. The user device may repeat the process of determining a location, receiving a wireless signal, and associating the location and the wireless signal for a plurality of physical control of the remote control device.

In one or more embodiments, the user may then operate the user device to control a target device. The user may open an application on the user device for controlling the target device. The user device may present the image of the remote control device to the user on the display. The user device may receive a user selection of a location on the image, and transmit a wireless signal that is associated with the location to operate the target device.

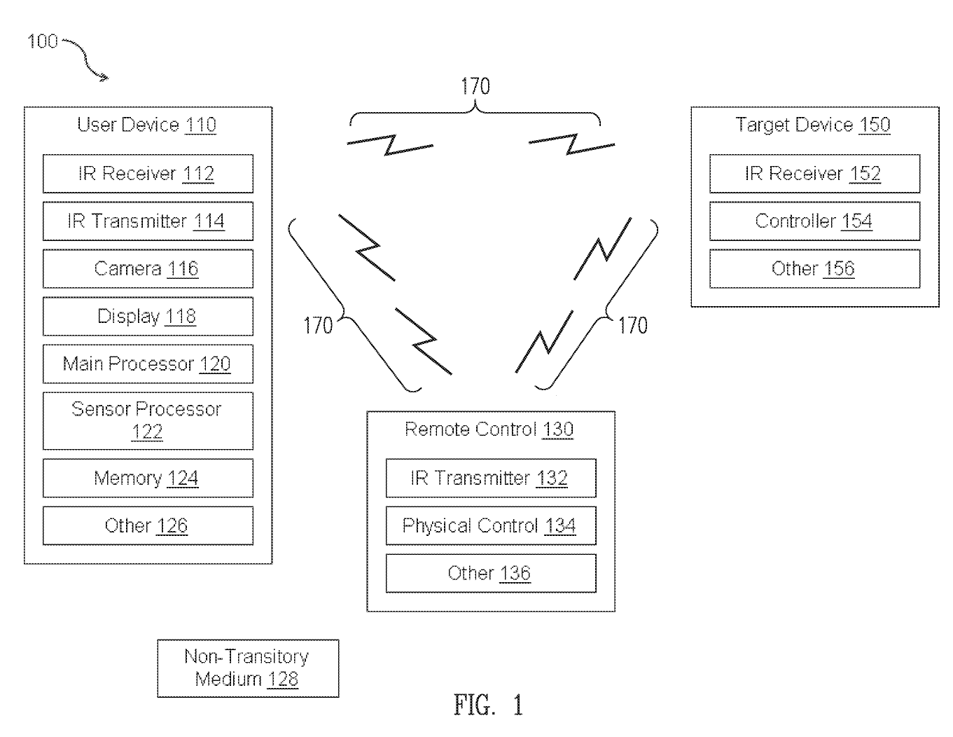

Referring now to the drawings, FIG. 1 illustrates a block diagram of a system 100 for programming a user device 110 with a remote control device 130 and operating user device 110 to remotely control a target device 150 in accordance with an embodiment of the disclosure, which may be used to implement various features discussed above.

User device 110, in one or more embodiments, may include IR ports (e.g., an IR receiver 112 and an IR transmitter 114), a camera 116, a display 118 (e.g., a touchscreen display in some embodiments), a main processor 120, a sensor processor 122, one or more memories 124, and/or other components 126. User device 110 may be a mobile phone (e.g., a smartphone, a cell phone, or other mobile phone), a wearable device, a smartwatch, a tablet, a laptop, a notebook computer, a personal computer, or other mobile computing device.

IR receiver 112 may be configured to receive IR signals 170 from remote control device 110. IR transmitter 114 may be configured to transmit IR signals 170. In some embodiments, IR transmitter 114 may be an IR light-emitting diode (LED), and IR receiver 112 may be a separate component from IR transmitter 114. For example, IR receiver 112 may be a separate IR photodiode. In another example, IR receiver 112 may be implemented as an IR proximity sensor, for example, an IR proximity sensor adjacent to an earpiece speaker configured to detect the presence of nearby objects such as the human ear. In other embodiments, IR receiver 112 and IR transmitter 114 may be implemented as a single IR transceiver, such as an IR LED. In an example, an IR LED may perform as IR transmitter 114 and also as a less efficient IR receiver 112. As remote control device 130 may be in close proximity to user device 110 when IR signals 170 are sent from remote control device 130 to user device 110, the optical power of IR signals 170 received by the IR LED may be very high, thus reducing the effect of the inefficiency of the IR LED as IR receiver 112. In some embodiments, camera 116 may be implemented to detect IR radiation and may be used in addition to, or in place of, IR receiver 112.

Although various embodiments are discussed herein in terms of IR communication (e.g., using IR signals 170, IR receiver 112, IR transmitter 114, and IR interfaces 402/502), other types of signals may be used with other types of communication ports and associated interfaces. For example, in some embodiments, the wireless signal may be an RF signal (e.g., a Wi-Fi™ signal or Bluetooth™ signal) and user device 110 may be provided with one or more antennas (e.g., providing one or more RF receivers, RF transmitters, and/or RF transceivers) and a Wi-Fi™ interface or a Bluetooth™ interface. In some embodiments, the wireless signal may be an optical signal, such as a visible light signal, and camera 116 or other visible light sensor may operate as a communication port.

Camera 116 may be configured to capture images of remote control device 130 when positioned in a field-of-view (FOV) of camera 116. For example, in some embodiments, camera 116 may be a built-in camera of a smartphone and/or an attached or remote camera in wired or wireless communication with user device 110.

Display 118 may be configured to present to a user various icons, images, and/or text (e.g., through a graphical user interface (GUI) or otherwise) provided by one or more applications running on main processor 120. For example, display 118 may be configured to present images, such as images captured by camera 116. Further, display 118 may be a touchscreen display configured to receive user input and user selection based on user contact with the touchscreen. Touchscreen may generate a signal in response to a user contact and transmit the signal to main processor 120. A user may thus interact with the information presented on the touchscreen.

Main processor 120 and/or sensor processor 122 may be configured to execute instructions, such as software instructions, provided in one or more memories 124 and/or stored in non-transitory form in one or more non-transitory machine-readable mediums 128 (e.g., a memory or other appropriate storage medium internal or external to user device 110). Main processor 120 may include one or more microprocessors, logic devices, microcontrollers, application specific integrated circuits (ASICs), or other suitable processing systems and be configured to run one or more applications as further discussed herein. Sensor processor 122 may be a PLD (e.g., a field programmable gate array (FPGA)), a complex programmable logic device (CPLD), a field programmable system on a chip (FPSC), a micro-controller unit (MCU), or other type of programmable device) or a hardwired logic device, such as an application-specific integrated circuit (ASIC).

Remote control device 130, in one or more embodiments, may include an IR transmitter 132 (e.g., an IR LED), one or more physical controls 134 (e.g., a button, a switch, a control stick, or other control), and/or other components 136. Remote control device 130 may be a remote control associated with target device 150 configured to operate target device 150 by transmitting IR signals 170 via IR transmitter 132 in response to a user actuating physical control 134 (e.g., pressing a button). Other components 136 may include, for example, a logic device configured to modulate IR signals 170 transmitted by IR transmitter 132. The logic device may, for example, implement one or more protocols to transmit IR commands (e.g., RC-5 protocol developed by Philips™, SIRCS protocol developed by Sony™, and/or others as appropriate).

Target device 150, in one or more embodiments, may include an IR receiver 152 (e.g., an IR photodiode or other IR sensor), a controller 154, and/or other components 156. Target device 150 may be an appliance (e.g., a television (TV), a cable TV controller, an air conditioner, a fan, or others), a garage or gate, or other target device. Target device 150 may receive an IR signal 170 via IR receiver 152, and controller 154 may perform a command (e.g., turn on, turn off, play, pause, stop, change channel, etc.) corresponding to the IR signal 170. Other components 156 may include, for example, components specific to an appliance, such as a display and audio/video (A/V) input for a TV.

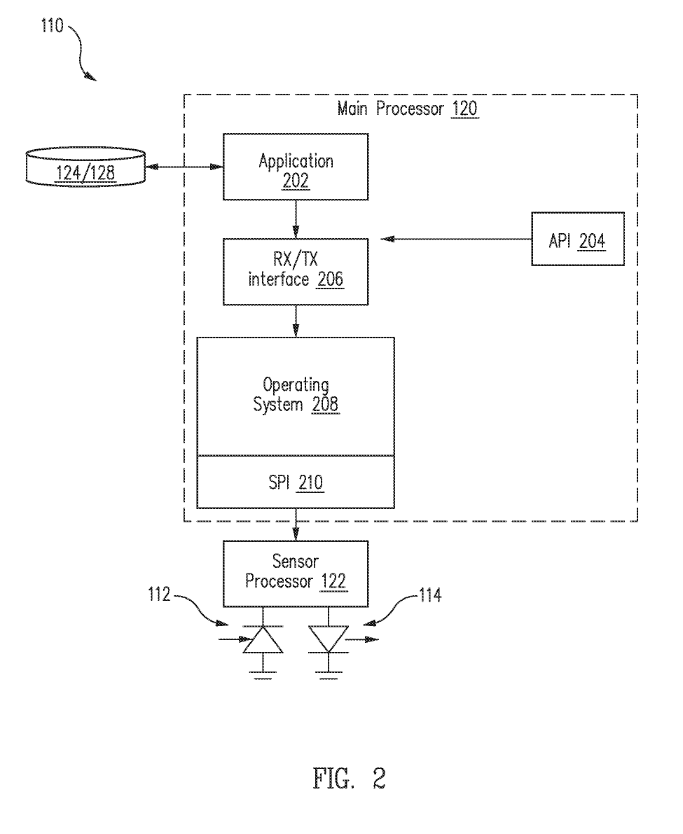

FIG. 2 illustrates a block diagram of a user device, such as user device 110 in FIG. 1, in accordance with an embodiment of the disclosure. Main processor 120 may include one or more applications 202, an application programming interface 204, a receiver and transmitter interface 206, an operating system 208, and a serial peripheral interface (SPI) 210. Main processor 120 may be configured to store data or information in memory 124 or non-transitory machine-readable medium 128. Main processor 120 may be configured to communicate with sensor processor 122. Main processor 120 may further be configured to communicate with IR receiver 112, via sensor processor 122 and/or directly therewith, to receive IR signals 170, and communicate with IR transmitter 114, via sensor processor 122 and/or directly therewith, to transmit IR signals 170.

In some embodiments, application 202 may be application software written in a computer programming language such as Java™ or other computer programming language (e.g., Objective-C, Swift, or others), and may be in an appropriate packaged file format (e.g., an Android application package (APK) or others as appropriate) configured to be distributed, installed, and run on main processor 120. Application 202 may present information (e.g., icons, images, and/or text) on display 118 of user device 110 in FIG. 1. Application 202 may provide a programming mode that may be used to program user device 110 to remotely control target device 150, and an operating mode that may be used to operate user device 110 to remotely control target device 150.

Application programming interface (API) 204 may be provided, at least in part, by receiver/transmitter interface 206 running on main processor 120 and configured to enable application 202 to call and be called by operating system 208 and other programs specific to and/or associated with sensor processor 122, IR receiver 112, and IR transmitter 114. In some embodiments, receiver/transmitter interface 206 may be provided as a Java native interface (JNI) or other programming framework.

Operating system 208 (e.g., Android™ of Google™ iOS™ of Apple™, Windows™ of Microsoft™, or others) configures main processor 120 to manage various hardware and software components of user device 110 and provide services for the various hardware and software components. In this regard, it will be appreciated that additional software (e.g., executable instructions) may be provided as part of or in communication with operating system 208 to implement appropriate communication between various components of user device 110 including, for example, TCP/IP stack and/or UDP stack, drivers for camera 116 (e.g., to permit application 202 to access camera 116), and/or other operations.

Operating system 208 may be configured to communicate with sensor processor 122 over SPI interface 210. In other embodiments, one or more other interfaces may be utilized in place of or in addition to SPI interface 210, such as Inter-IC (I2C) bus, General Purpose IO (GPIO), and/or other interfaces.

During programming of user device 110, sensor processor 122 may receive an IR signal via IR receiver 112 in response to an actuation of a physical control 134 of remote control device 130 in FIG. 1. Sensor processor 122 may generate command code data by decoding the IR signal, and provide a command code (e.g., the command code data or a memory address associated with the command code data) corresponding to the IR signal over SPI interface 210. Operating system 208 may provide the command code to application 202 via receiver/transmitter interface 206. Application 202 may store the command code and an association between the command code and a location on an image of remote control device 130 corresponding to the physical control in memory 124 or non-transitory machine-readable medium 128.

During operation of user device 110 to control target device 150 in FIG. 1, application 202 may present an image of remote control device 130 on display 118 of user device 110 in FIG. 1. Application 202 may access memory 124 or non-transitory machine-readable medium 128 for a command code in response to receiving a user selection of a location on the image corresponding to physical control 134 of remote control device 130 in FIG. 1. Application 202 may provide the command code to operating system 208 via receiver/transmitter interface 206. Operating system 208 may send the command code to sensor processor 122 over SPI interface 210, and sensor processor may encode an IR signal based on the command code and transmit the IR signal to operate target device 150 in FIG. 1.

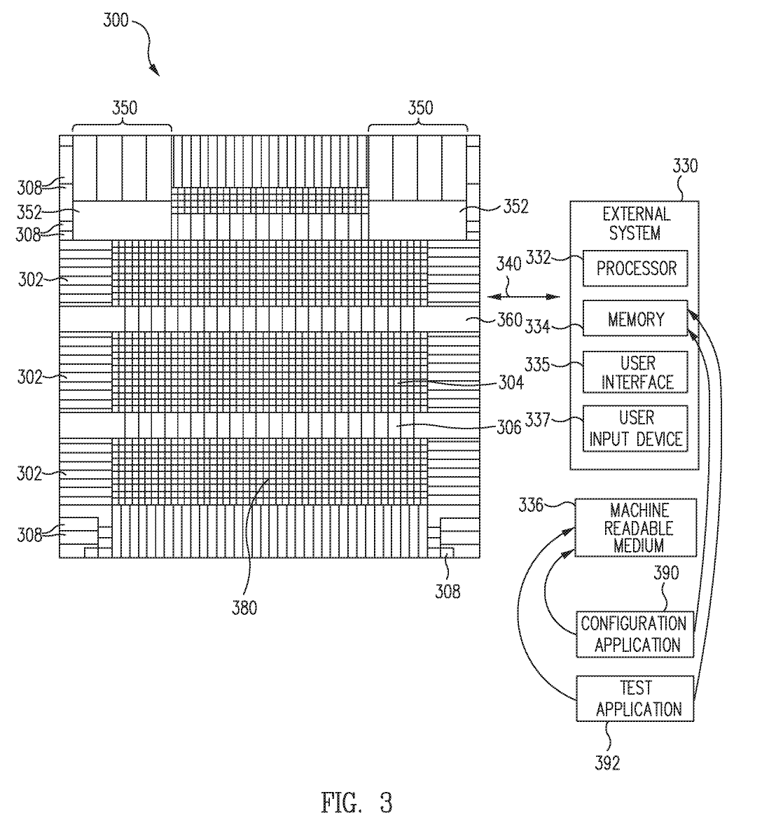

FIG. 3 illustrates a block diagram of a PLD 300, which may be implemented as sensor processor 122 in FIG. 1, in accordance with an embodiment of the disclosure. PLD 300 (e.g., a field programmable gate array (FPGA), a complex programmable logic device (CPLD), a field programmable system on a chip (FPSC), or other type of programmable device) generally includes input/output (I/O) blocks 302 and logic blocks 304 (e.g., also referred to as programmable logic blocks (PLBs), programmable functional units (PFUs), or programmable logic cells (PLCs)).

I/O blocks 302 provide I/O functionality (e.g., to support one or more I/O and/or memory interface standards) for PLD 300, while programmable logic blocks 304 provide logic functionality (e.g., LUT-based logic or logic gate array-based logic) for PLD 300. Additional I/O functionality may be provided by serializer/deserializer (SERDES) blocks 350 and physical coding sublayer (PCS) blocks 352. PLD 300 may also include hard intellectual property core (IP) blocks 360 to provide additional functionality (e.g., substantially predetermined functionality provided in hardware which may be configured with less programming than logic blocks 304).

PLD 300 may also include blocks of memory 306 (e.g., blocks of EEPROM, block SRAM, and/or flash memory), clock-related circuitry 308 (e.g., clock sources, PLL circuits, and/or DLL circuits), and/or various routing resources 380 (e.g., interconnect and appropriate switching logic to provide paths for routing signals throughout PLD 300, such as for clock signals, data signals, or others) as appropriate. In general, the various elements of PLD 300 may be used to perform their intended functions for desired applications, as would be understood by one skilled in the art.

For example, I/O blocks 302 may be used for programming PLD 300, such as memory 306 or transferring information (e.g., various types of data and/or control signals) to/from PLD 300 through various external ports as would be understood by one skilled in the art. I/O blocks 302 may provide a first programming port which may represent a central processing unit (CPU) port, a peripheral data port, an SPI interface (e.g., used to implement SPI interface 210), and/or a sysCONFIG programming port, and/or a second programming port such as a joint test action group (JTAG) port (e.g., by employing standards such as Institute of Electrical and Electronics Engineers (IEEE) 1149.1 or 1532 standards). I/O blocks 302 typically, for example, may be included to receive configuration data and commands (e.g., over one or more connections 340) to configure PLD 300 for its intended use and to support serial or parallel device configuration and information transfer with SERDES blocks 350, PCS blocks 352, hard IP blocks 360, and/or logic blocks 304 as appropriate.

It should be understood that the number and placement of the various components of PLD 300 are not limiting and may depend upon the desired application. For example, various components may not be required for a desired application or design specification (e.g., for the type of PLD used). Furthermore, it should be understood that the components are illustrated in block form for clarity and that various components would typically be distributed throughout PLD 300, such as in and between logic blocks 304, hard IP blocks 360, and routing resources 380 to perform their conventional functions (e.g., storing configuration data that configures PLD 300 or providing interconnect structure within PLD 300). It should also be understood that the various embodiments disclosed herein are not limited to programmable logic devices, such as PLD 300, and may be applied to various other types of programmable devices, including but not limited to MCUs, as would be understood by one skilled in the art.

An external system 330 (e.g., also referred to as an external device) may be used to create a desired user configuration or design of PLD 300 and generate corresponding configuration data to program (e.g., configure) PLD 300. For example, system 330 may provide such configuration data to one or more I/O blocks 302, SERDES blocks 350, and/or other portions of PLD 300. As a result, programmable logic blocks 304, routing resources 380, and any other appropriate components of PLD 300 may be configured to operate in accordance with user-specified applications.

In the illustrated embodiment, system 330 is implemented as a computer system. In this regard, system 330 includes, for example, one or more processors 332 which may be configured to execute instructions, such as software instructions, provided in one or more memories 334 and/or stored in non-transitory form in one or more non-transitory machine-readable mediums 336 (e.g., a memory or other appropriate storage medium internal or external to system 330). For example, in some embodiments, system 330 may run a PLD configuration application 390, such as Lattice Diamond System Planner software available from Lattice Semiconductor Corporation to permit a user to create a desired configuration and generate corresponding configuration data to program PLD 300. In some embodiments, system 330 may run a test application 392 (e.g., also referred to as a debugging application), such as Lattice Reveal software available from Lattice Semiconductor Corporation to evaluate the operation of PLD 300 after it has been configured.

System 330 also includes, for example, a user interface 335 (e.g., a screen or display) to display information to a user, and one or more user input devices 337 (e.g., a keyboard, mouse, trackball, touchscreen, and/or other device) to receive user commands or design entry to prepare a desired configuration of PLD 300 and/or to identify various triggers used to evaluate the operation of PLD 300, as further described herein.

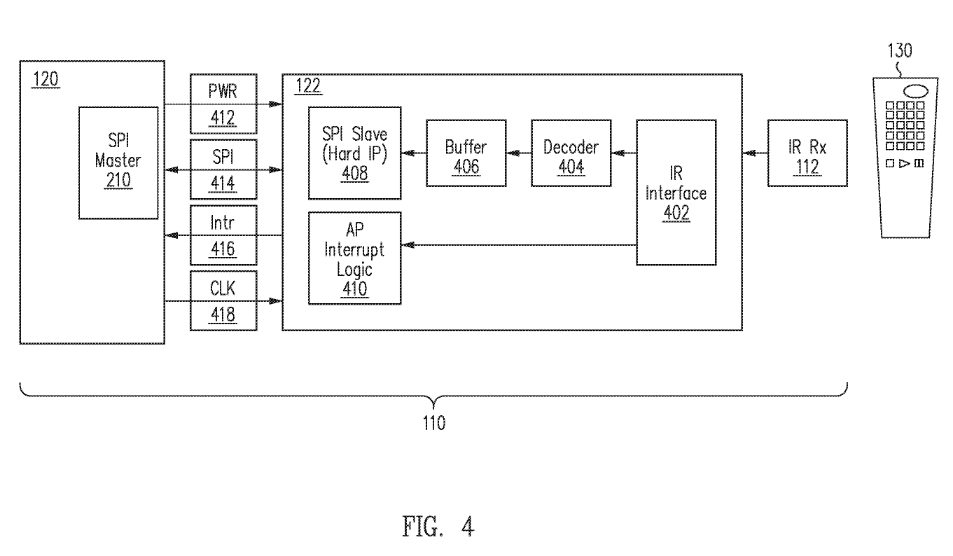

FIG. 4 illustrates a block diagram of a user device, such as user device 110 in FIG. 1, interacting with a remote control device, such as remote control device 130 in FIG. 1, in accordance with an embodiment of the disclosure. As shown, main processor 120 is in communication with sensor processor 122 over various signals including a power signal 412, SPI interface signals 414 (e.g., a serial clock signal, a master output/slave input signal, a master input/slave output signal, and a slave select signal provided over corresponding pins of main processor 120), an interrupt signal 416, and a clock signal 418.

As discussed, sensor processor 122 may be implemented by PLD 300. As shown, sensor processor 122 may include an IR interface 402, a decoder 404, a buffer 406, and a SPI interface 408. SPI interface 408 (e.g., the SPI slave), which may be implemented as hard intellectual property core (IP) blocks 360 in FIG. 3, may communicate SPI signals 414 (e.g., a serial clock signal, a master output/slave input signal, a master input/slave output signal, and a slave select signal) with SPI interface 210 (e.g., the SPI master) of main processor 120. Further, applications processor (AP) interrupt logic 410 (e.g., implemented by logic blocks 304 of PLD 300) may communicate interrupt signal 416 to main processor 120. Main processor 120 may provide clock signal 418 to sensor processor 122, which may be a serial clock signal of the SPI signals 414 or a separate clock signal in various embodiments.

IR receiver 112 may receive an IR signal (e.g., IR signal carried by IR radiation/IR energy), such as IR signal 170 in FIG. 1, from remote control device 130 and transmit the received IR signal (e.g., as IR signal data and/or IR signal carried by electrical current) to IR interface 402. IR interface 402 (e.g., implemented by one or more I/O blocks 302 of PLD 300 providing a port) may communicate with AP interrupt logic 410 in response to receiving the IR signal, and AP interrupt logic 410 may send interrupt signal 416 to main processor 120. In response to receiving interrupt signal 416, main processor 120 may configure SPI interface 210 to communicate with SPI interface 408, such as by waking sensor processor 122 by power signal 412 and/or sending a slave select signal to activate SPI interface 408.

Decoder 404 (e.g., implemented by one or more logic blocks 304 of PLD 300) may receive the IR signal from IR interface 402 and decode the IR signal to generate command code data. Decoder 404 may store various portions of the command code data in buffer 406 (e.g., implemented by one or more memory blocks 306 of PLD 300), for example, while decoder 404 is decoding the IR signal. The command code data and/or a memory address (e.g., a pointer) of buffer 406 may be transmitted from buffer 406 over SRI interface 408 of sensor processor 122 to be received by SPI interface 210 of main processor 120 via SPI signals 414. In some embodiments, clock signal 418 may be utilized to synchronize decoder 404 when generating the command code data. In other embodiments, a clock generated internally to sensor processor 122 can be utilized to synchronize decoder 404. In some embodiments, main processor 120 may decode the IR signal data at one or more pins of main processor 120 (e.g., SPI interface 210 or other interfaces implemented by pins of main processor 120) directly connected to IR receiver 112, thus bypassing the use of buffer 406, encoder 404, and IR interface 402 in such embodiments.

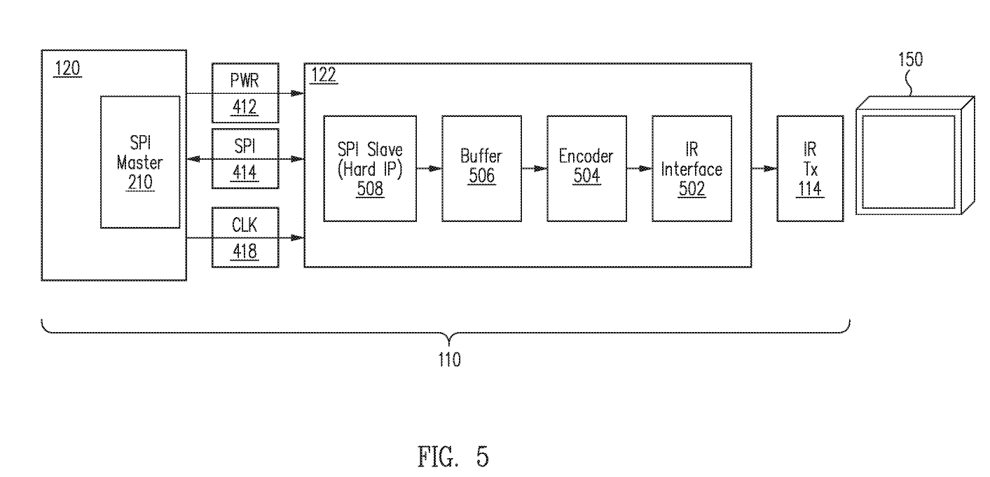

FIG. 5 illustrates a block diagram of a user device, such as user device 110 in FIG. 1, interacting with a target device, such as target device 150 in FIG. 1, in accordance with an embodiment of the disclosure. As shown, main processor 120 is in communication with sensor processor 122 over various signals 412, 414, and 418 as previously discussed.

As discussed, sensor processor 122 may be implemented by PLD 300. As shown, sensor processor 122 may include an SPI interface 508, a buffer 506, an encoder 504, and an IR interface 502. SPI interface 508 (e.g., an SPI slave) may be implemented in the same or similar manner as SPI interface 408 of FIG. 4. In response to receiving interrupt signal 416 (not shown in FIG. 5), main processor 120 may configure SPI interface 210 to communicate with SPI interface 408, such as by waking sensor processor 122 by power signal 412 and/or sending a slave select signal to activate SPI interface 408. Main processor 120 may then transmit command code data and/or a memory address (e.g., a pointer) of buffer 506 corresponding to the command code data over SRI interface 210 to be received by SPI interface 508 via SPI signals 414. Sensor processor 122 may store various portions of the command code data in buffer 506 (e.g., implemented by one or more memory blocks 306 of PLD 300).

Encoder 504 (e.g., implemented by one or more programmable logic blocks 304 of PLD 300) may receive the command code data from buffer 506 and encode the command code data as IR signal data provided to IR interface 502 (e.g., implemented in the same or similar manner as IR interface 402 previously discussed). In some embodiments, clock signal 418 may be utilized to synchronize encoder 506 when encoding the command code data as IR signal data. IR transmitter 114 may receive the IR signal data from IR interface 502 and transmit one or more IR signals to operate target device 150. In some embodiments, main processor 120 may be encode the IR signal data at one or more pins of main processor 120 (e.g., SPI interface 210 or other interfaces implemented by pins of main processor 120) directly connected to IR transmitter 114, thus bypassing the use of buffer 506, encoder 504, and IR interface 502 in such embodiments.

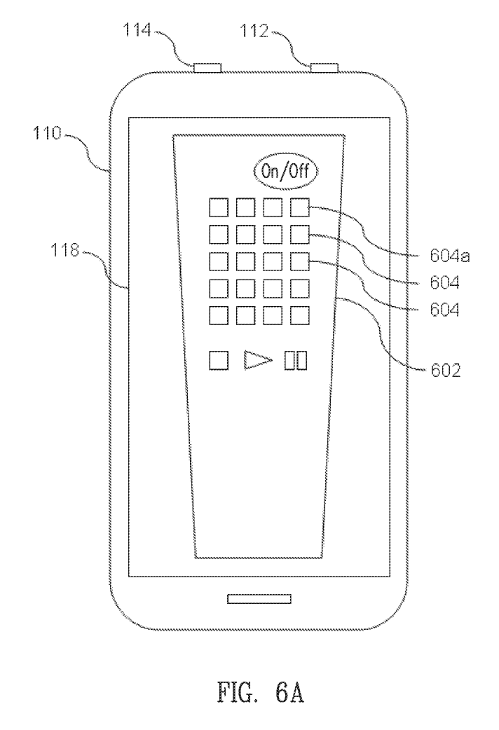

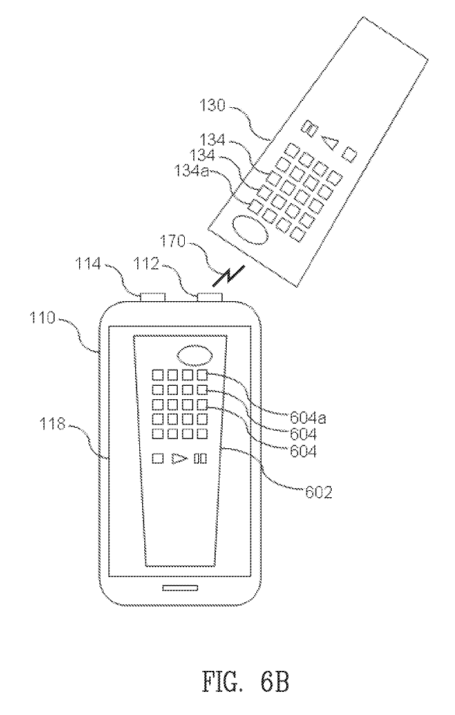

FIG. 6A illustrates a block diagram of a user device, such as user device 110 in FIG. 1, presenting an image 602 of a remote control device on a display, such as display 118 in FIG. 1, in accordance with an embodiment of the disclosure. Image 602 may be captured by camera 116 (in FIG. 1) of user device 110. Image 602 may graphically represent remote control device 110. In this regard, image 602 may include physical controls 604 that photographically represent and correspond to physical controls 134 of remote control device 130.

FIG. 6B illustrates a block diagram of a user device, such as user device 110 in FIG. 1, placed within range of infrared signals, such as infrared signals 170 in FIG. 1, of a remote control device, such as remote control device 130 in FIG. 1, in accordance with an embodiment of the disclosure.

In one or more embodiments, during programming of user device 110, a user may provide a user input by contacting (e.g., touching) a location on image 602 that illustrating a physical control 604 (e.g., physical control 604a) which photographically represents an actual physical control 134 (e.g., physical control 134a) of remote control device 130. User device 110 may determine the location in response to the user input. In other embodiments, user device 110 may process image 602 to identify physical controls 604 in image 602, and select one of physical controls 604 (e.g., physical control 604a) to identify a location.

In one or more embodiments, during programming of user device 110, a user may actuate one of physical controls 134a that corresponds to the illustrated physical control 604a before or after contacting physical control 604a in image 602 as described. User device 110 may receive an IR signal associated with physical control 134a from remote control device 130 via IR receiver 114. User device 110 may associate the IR signal (e.g., a representation of the IR signal) with the location determined by user device 110 as discussed.

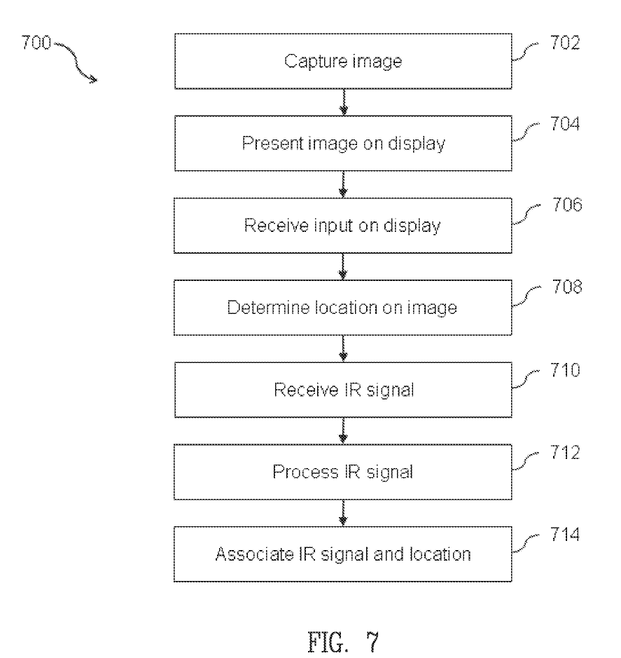

FIG. 7 illustrates a flow diagram 700 of programming a user device, such as user device 110 in FIG. 1, with a remote control device, such as remote control device 130 that includes one or more physical controls 134 in FIG. 1, to remotely control a target device, such as target device 150 in FIG. 1, in accordance with an embodiment of the disclosure. An application, such as application 202 in FIG. 2, may provide user device 110 a programming mode in which some or all of blocks 702-712 may be performed by user device 110.

At block 702, user device 110 captures an image, such as image 602 in FIGS. 6A-B, of remote control device 130. In one or more embodiments, a camera of user device 110, such as camera 116 in FIG. 1, may capture image 602. In some embodiments, images 602 of some remote control devices 130 may be preloaded on user device 110.

At block 704, user device 110 presents image 602 on a display, such as display 118 in FIG. 1 and FIGS. 6A-B. In some embodiments, prior to and/or during block 704, image 602 may be manipulated (e.g., by the user, the application 202, and/or the operating system 208), for example, by zooming in or out or otherwise adjusted as desired to prepare the captured image for display.

At block 706, user device 110 receives a user input (e.g., a user contact) on display 118. At block 708, user device 110 determines a location on image 602. In one or more embodiments, user device 110 may determine the location based on the user contact at block 706. A main processor of user device 110, such as main processor 120 in FIGS. 1, 2, and 4, may generate data identifying the location on the image based on the signal generated by the display in response to the user contact corresponding to the location. In some embodiments, user device 110 may process image 602 to identify physical controls 604 in image 602 and select one of physical controls 604a to identify the location. In one example, user device 110 may automatically select physical control 604a, and block 706 may be skipped. In another example, device 110 may process image 602 to identify physical controls 604 in image 602, receive the user contact on display 118 at block 706, and select one of physical controls 604a based on the user contact to identify the location. In further embodiments, the user may manually identify and/or edit the location using an image editing application to provide better response when operating user device 110 to control target device 150.

At block 710, user device 110 receives an IR signal from remote control device 130 corresponding to an actuation of one of physical controls 134a. In one or more embodiments, the user may align remote control device 130 to aim at user device 110 and actuate physical control 134a. An IR receiver of user device 110, such as IR receiver 112 in FIG. 1, may receive the IR signal and transmit the received IR signal to a sensor processor of user device 110, such as sensor processor 122 in FIGS. 1, 2, and 4, as IR signal data and/or IR signal information carried by electric current that includes various features of the IR signal (e.g., IR signal carrier frequency and pulse modulation characteristics).

At block 712, user device 110 processes the IR signal. In one or more embodiments, sensor processor 122 may process the IR signal by decoding the IR signal to provide command code data as discussed. At block 714, user device 110 associates the IR signal (e.g., as a representation of the IR signal) with the location on image 602. In one or more embodiments, sensor processor 122 may communicate the command code data to main processor 120, via an SPI interface (e.g., SPI slave 408 and SPI master 210 in FIG. 4), and main processor 120 may store an association between the command code data with the location in a memory, such as memory 124 or non-transitory medium 128 in FIG. 1. In other embodiments, sensor processor 122 may store the command code data in a memory of sensor processor 122 at a memory location as discussed. Sensor processor 122 may transmit a memory address associated with the memory location to main processor 120, and main processor 122 may store an association between the memory address and the location in a memory, such as memory 124 or non-transitory medium 128.

In various embodiments, blocks 706-714 may be repeated as desired a plurality of IR signals, each corresponding to actuation of a respective physical control 134 of remote control device 130. Further, blocks 702-714 may be repeated as desired for a plurality of remote control devices 130. As a result, user device 110 may be configured to store various associations for multiple physical controls 134 of multiple remote control devices 130.

In one or more embodiments, during operation of user device 110 to control target device 150, a user may provide a user input by contacting (e.g., touching) a location on image 602 illustrating a physical control 604 (e.g., physical control 604a) which photographically represents an actual physical control 134 (e.g., physical control 134a) of remote control device 130. User device 110 may transmit an IR signal associated with the location via IR transmitter 114.

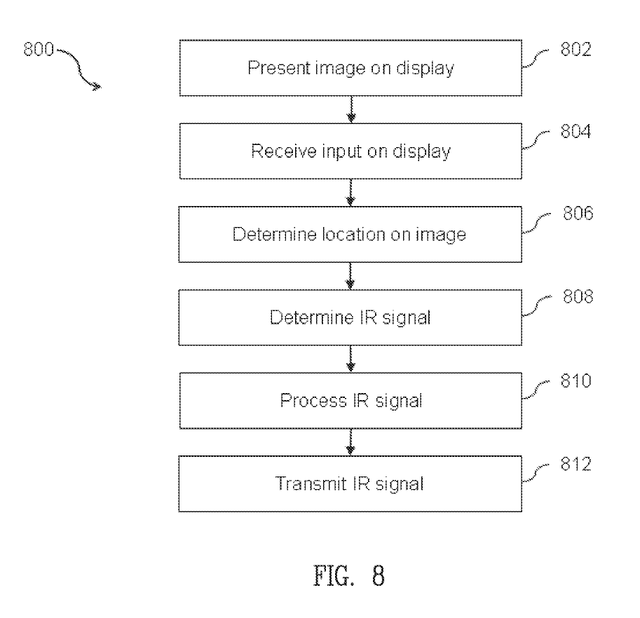

FIG. 8 illustrates a flow diagram 800 of operating a user device, such as user device 110 in FIG. 1, to remotely control a target device, such as target device 150 in FIG. 1, in accordance with an embodiment of the disclosure. An application, such as application 202 in FIG. 2, may provide an operation mode on user device 110 in which some or all of blocks 802-812 may be performed by user device 110.

At block 802, user device 110 presents an image, such as image 602 in FIGS. 6A-B, on a display, such as display 118 in FIG. 1 and FIGS. 6A-B. In one or more embodiments, a user may select one of a plurality of remote control devices 130, and an image 602 of selected remote control device 130 may be presented.

In some embodiments, prior to and/or during block 802, image 602 may be manipulated as discussed. For example, image 602 may be zoomed allow the user to focus on frequently used physical controls 604 in image 602. In another example, image 602 may be edited by the user, such as by performing copy, cut, and/or paste operations to adjust the presentations of physical controls 604 in image 602. In further examples, the user may combine images 602 of a plurality of remote control devices 130 and/or physical controls 604 in a single composite image corresponding to physical controls 134 of a plurality of remote control devices 130.

At block 804, user device 110 receives a user input on display 118. In one or more embodiments, user device 110 may receive a user contact, for example, in response to a user contacting (e.g., touching) display 118 at or near physical control 604a in image 602.

At block 806, user device 110 determines a location on image 602. In one or more embodiments, user device 110 may determine the location to be physical control 604a in image 602 based on the user contact at block 804.

At block 808, user device 110 determines an IR signal (e.g., a representation of the IR signal) associated with the location determined at block 806. In one or more embodiments, a main processor of user device 110, such as main processor 120 in FIGS. 1, 2, and 4, may access a memory, such as memory 124 or non-transitory medium 128 in FIG. 1, to determine command code data associated with the location.

In some embodiments, main processor 120 may transmit command code data associated with the location to a sensor processor, such as sensor processor 122 of FIGS. 1, 2, and 4, through SPI interfaces 210 and 408 of FIG. 4.

In other embodiments, main processor 120 may transmit command code data associated with all locations on image 602 to sensor processor 122 over the SPI interface when the user selects one of a plurality of remote control devices 130 at block 802. As command code data for each of the locations on image 602 has been transmitted to sensor processor 122, main processor 120 may subsequently just send a memory address to sensor processor 122 for each user selected location (e.g., sensor processor 122 may retrieve the associated command code data for each selected location from its associated memory address).

In further embodiments, command code data may be stored in a memory in sensor processor 122, such as memory 306 in FIG. 3, and main processor 120 may transmit a memory address associated with the location to sensor processor 122.

At block 810, user device 110 processes the IR signal. In one or more embodiments, sensor processor 122 may encode the command code data associated with the location and provide the IR signal corresponding to an actuation of a respective physical control, such as physical control 134a, to an IR transmitter, such as IR transmitter 114 in FIGS. 1, 3, and 4.

At block 812, user device 110 transmits the IR signal to operate target device 150. In one or more embodiments, IR transmitter 114, which may be an IR light emitting diode, transmits the IR signal as an IR light signal. Target device 150 may receive the IR signal and perform an operation (e.g., turn on, turn off, play, pause, stop, change channel, or other operation) corresponding to the IR signal.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
capturing an image of a remote control device by a camera of a user device, wherein the remote control device comprises at least one physical control;
determining a location on the image corresponding to the physical control;
receiving, at the user device, a wireless signal from the remote control device corresponding to an actuation of the physical control; and
associating a stored representation of the wireless signal with the location on the image.

2. The method of claim 1, further comprising:
presenting the image on a touchscreen display of the user device;
receiving a user contact on the touchscreen display corresponding to the location; and
transmitting a wireless signal from the user device, in response to the user contact, to operate a target device.

3. The method of claim 2, further comprising:
decoding the received wireless signal to provide command code data;
storing the command code data as the representation of the wireless signal; and
encoding the command code data to provide the transmitted wireless signal in response to the user contact.

4. The method of claim 3, wherein the decoding and the encoding are performed by a programmable logic device (PLD) of the user device.

5. The method of claim 4, wherein:
the associating comprises storing, by an application running on a microprocessor of the user device, an association between the command code data and the location; and
the method further comprises providing, by the application, the command code data to the PLD in response to the user contact.

6. The method of claim 4, wherein:
the associating comprises:
storing, in one or more memory locations of the PLD, the command code data, and
storing, by an application running on a microprocessor of the user device, an association between a memory address associated with the one or more memory locations and the location on the image; and
the method further comprises providing, by the application, the memory address to the PLD in response to the receiving of the user contact.

7. The method of claim 2, wherein the wireless signal is an infrared (IR) signal, wherein the receiving the wireless signal from the remote control device comprises receiving IR energy at an IR light-emitting diode (LED) of the user device, and wherein the transmitting the wireless signal comprises transmitting IR energy from the IR LED.

8. The method of claim 1, wherein the determining comprises:
presenting the image on a touchscreen display of the user device; and
receiving a user contact on the touchscreen display to determine the location on the image.

9. The method of claim 1, wherein the determining comprises:
processing the image to identify the physical control in the image; and
selecting the physical control in the image to identify the location on the image.

10. The method of claim 1, wherein the user device is a mobile phone, wherein the wireless signal is one of an infrared (IR) signal, a radio frequency (RF) signal, a visible light signal, a Wi-Fi™ signal, or a Bluetooth™ signal.

11. The method of claim 1, further comprising repeating the determining, the receiving, and the associating for a plurality of physical controls and a plurality of wireless signals of the remote control device.

12. A device comprising:
a camera configured to capture an image of a remote control device, wherein the remote control device comprises at least one physical control;
a communication port configured to receive a wireless signal from the remote control device corresponding to an actuation of the physical control; and
a microprocessor configured to obtain data identifying a location on the image corresponding to the physical control and to associate a representation of the wireless signal with the data identifying the location on the image.

13. The device of claim 12, further comprising:
a touchscreen display configured to present the image and receive a user contact corresponding to the location;
wherein the microprocessor is configured to produce the data identifying the location on the image based on a signal generated by the touchscreen display in response to the user contact corresponding to the location; and
wherein the communication port is configured to transmit the wireless signal generated based on the representation of the wireless signal, in response to a user contact on the touchscreen display corresponding to the identified location on the image, to operate a target device.

14. The device of claim 13, further comprising a programmable logic device (PLD) in communication with the microprocessor and configured to:
decode the received wireless signal to provide command code data;
store the command code data as the representation of the wireless signal; and
encode the command code data to provide the wireless signal to be transmitted by the communication port in response to the user contact.

15. The device of claim 14, wherein the microprocessor is configured to run an application configured to:
provide a programming mode in which the image is presented on the touchscreen display and the microprocessor is programmed to generate the data identifying the location on the image based on the signal generated by the touchscreen display in response to the user contact corresponding to the location and to store an association between the command code data and the location; and
provide an operating mode in which the microprocessor is configured to display the image on the touchscreen display, and in response to contact with the touchscreen display that corresponds to the location stored in association with the command code data, to retrieve the command code data and provide the command code data to the PLD.

16. The device of claim 14, wherein:
the PLD comprises a memory configured to store the command code data at an associated memory address; and
the microprocessor is configured to run an application configured to:
store an association between the memory address and the location on the image, and
provide the memory address to the PLD in response to the user contact.

17. The device of claim 13, wherein the communication port is an infrared (IR) light emitting diode (LED), and wherein the wireless signal is an infrared (IR) signal.

18. The device of claim 12, further comprising a touchscreen display configured to present the image and receive a user contact to determine the location.

19. The device of claim 12, wherein the microprocessor is configured to:
process the image to identify the physical control in the image; and
select the physical control in the image to identify the location.

20. The device of claim 12, wherein the device is a mobile phone, and wherein the wireless signal is one of an infrared (IR) signal, a radio frequency (RF) signal, a visible light signal, a Wi-Fi™ signal, or a Bluetooth™ signal.
